(19) United States
(12) Patent Application Publication
(10) Pub. No.: US 2008/0058038 A1
(43) Pub. Date: Mar. 6, 2008

(54) PORTABLE ELECTRONIC DEVICE HAVING A HINGE MECHANISM

(75) Inventors: David V. Murdoch, Berkshire (GB); Sidney J. Bolt, Wiltshire (GB)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/469,038

(22) Filed: Aug. 31, 2006

(51) Int. Cl. H04M 1/00

(52) U.S. Cl. 455/575.3

(57) ABSTRACT

A portable electronic device (100) having a hinge mechanism (106) including a hinge barrel (202) connected to a first housing portion (102) of the device. The hinge mechanism also includes a hinge actuator (302) connected to a second housing portion (104) of the device. The hinge actuator enclosed in a first portion (204) of the hinge barrel facilitates rotation of the first and second housing portions in opposite directions about a first axis (208). The hinge mechanism includes a vibrator unit (402) enclosed in a second portion (206) of the hinge barrel, wherein the vibrator unit is configured to vibrate the portable electronic device.

### FIELD OF THE DISCLOSURE

The disclosure relates generally to portable electronic devices, and more specifically to hinge mechanisms for portable electronic devices.

### BACKGROUND

There is an increasing demand for smaller, thinner and sleeker portable electronic devices having advanced additional operational features and functions. Such portable electronic devices include mobile phones, laptops, palmtops and personal digital assistants (PDAs) among other portable electronic devices. Advanced additional operational features in these devices sometimes require additional printed circuit boards (PCBs) or electronic components, for example, microphones, speakers, hinge mechanism in clam-shell devices, vibrator units, one or more antennas, etc., that increase size.

The various aspects, features and advantages of the disclosure will become more fully apparent to those having ordinary skill in the art upon careful consideration of the following Detailed Description and the accompanying drawings described below. The drawings may have been simplified for clarity and are not necessarily drawn to scale.

### BRIEF DESCRIPTION OF THE DRAWINGS

FIG. 1 illustrates a portable electronic device;

FIG. 2 illustrates a cross-sectional view of a hinge mechanism for a portable electronic device;

FIG. 3 illustrates components of a first portion of a hinge barrel;

FIG. 4 illustrates components of a second portion of the hinge barrel, in accordance with an embodiment of the present invention.

### DETAILED DESCRIPTION

The disclosure describes a portable electronic device having a hinge mechanism including a hinge barrel, an actuator and a vibrator unit. The hinge barrel is connected to a first housing portion of the portable electronic device and includes first and second portions. The hinge actuator is connected to a second housing portion of the device. Further, the hinge actuator is enclosed in the first portion of the hinge barrel and facilitates rotation of the first and second housing portions in opposite directions. The vibrator unit is enclosed in the second portion of the hinge barrel and is configured to vibrate the portable electronic device.

The disclosure also describes an electronic device including first and second housing portions and a hinge barrel. The hinge barrel is coupled to the first housing portion and includes first and second portions. The first portion includes a hinge knuckle, a hinge shaft and a detent mechanism. The knuckle rotates about a first axis and is connected to the second housing portion. The shaft is coupled to the hinge knuckle. The detent mechanism is coupled to the hinge knuckle by the hinge shaft. The hinge detent mechanism facilitates rotation of the first and second housing portions in opposite directions. The second portion of the hinge barrel includes a vibrator unit.

In this document, relational terms such as first and second, and the like may be used solely to distinguish one entity or action from another entity or action without necessarily requiring or implying any actual such relationship or order between such entities or actions. The terms “comprises,” “comprising” and variations thereof are intended to cover non-exclusive inclusions, such that a process, method, article or apparatus that comprises a list of elements does not include only those elements but may include other elements not expressly listed or inherent to such process, method, article or apparatus. An element proceeded by “comprises . . . a” does not, without more constraints, preclude the existence of additional identical elements in the process, method, article or apparatus that comprises the element. The term “another” as used in this document, is defined as at least a second or more. The term “includes” as used herein, are defined as comprising.

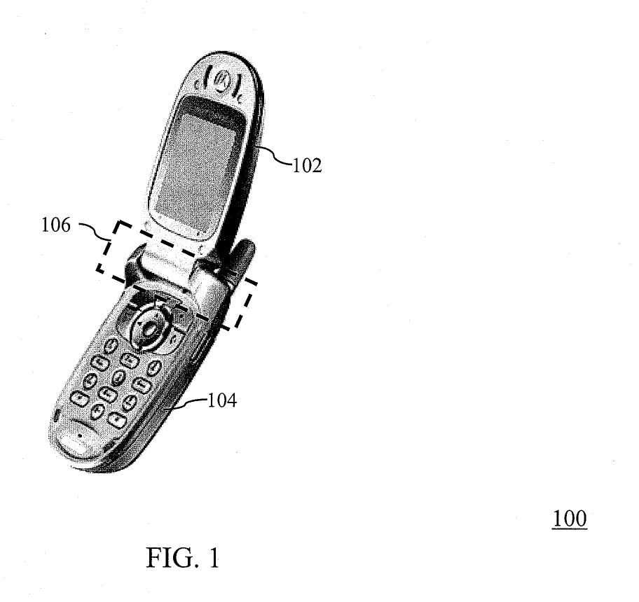

FIG. 1 illustrates an exemplary portable electronic device 100. Though the portable electronic device 100 is shown as a clam-shell mobile phone, it will be apparent to a person ordinarily skilled in the art that it may be any portable electronic device other than the clam-shell mobile phone, for example, a Personal Digital Assistant (PDA). The portable electronic device 100 includes a first housing portion 102 and a second housing portion 104. The first housing portion 102 may include a screen and a speaker. The second housing portion 104 may include a keypad and a microphone. The first housing portion 102 and the second housing portion 104 are rotationally coupled to each other via a hinge mechanism 106, which enables rotation of the first housing portion 102 and the second housing portion 104 in opposite directions, thereby achieving a flip-open position and a flip-closed position.

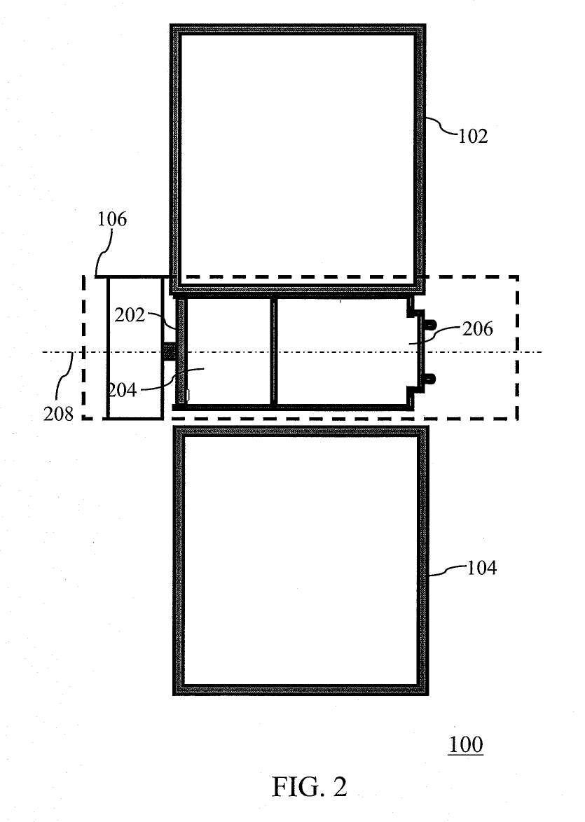

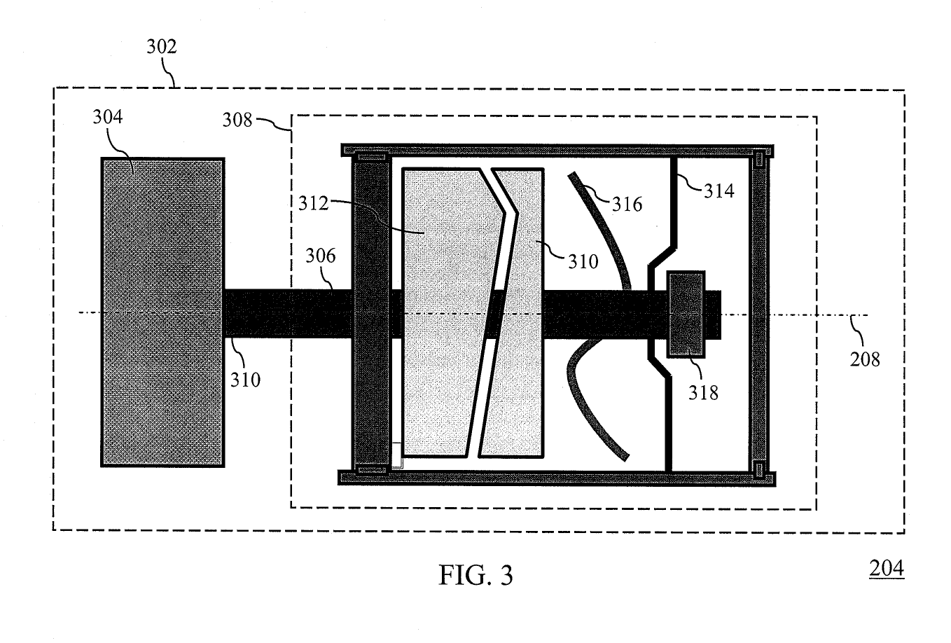

FIG. 2 illustrates a cross-sectional view of the hinge mechanism 106 of the exemplary portable electronic device 100. The hinge mechanism 106 includes a hinge barrel 202. The hinge barrel 202 is connected to the first housing portion 102 of the portable electronic device 100. Though the hinge barrel 202 is shown as being connected to the first housing portion 102, it will be apparent to a person ordinarily skilled in the art that the hinge barrel 202 may alternatively be connected to the second housing portion 104. The hinge barrel 202 also includes a first portion 204 and a second portion 206. The first portion 204 encloses a hinge actuator (shown in FIG. 3). The hinge actuator facilitates rotation of the first housing portion 102 and the second housing portion 104 in opposite directions about a first axis 208, thereby achieving the flip-open position and the flip-closed position. The components of the hinge actuator are described in conjunction with FIG. 3.

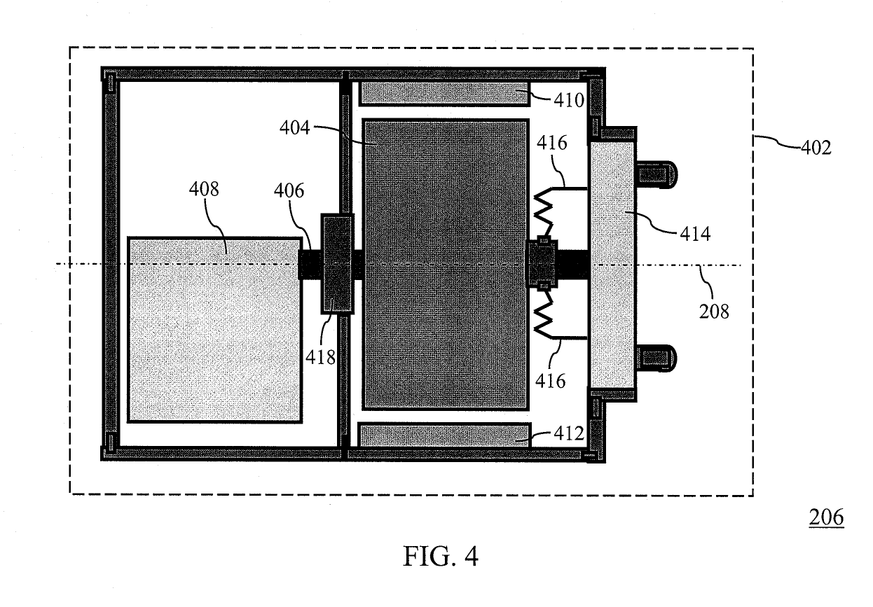

The second portion 206 encloses a vibrator unit (shown in FIG. 4). The vibrator unit is configured to vibrate the portable electronic device 100, notifying a user about an incoming call, an incoming text message, alert messages, etc. The components of the vibrator unit are described in conjunction with FIG. 4. Further, the hinge mechanism 106 includes a hinge bearing 210 around which the first housing portion 102 and the second housing portion 104 pivots. It may be apparent to a person ordinarily skilled in the art that the operational functioning of the hinge actuator and the vibrator unit will not interfere with the operational functioning of the hinge bearing 210, as they are physically separated.

FIG. 3 illustrates the components of the first portion of the hinge barrel. The first portion encloses a hinge actuator 302. The hinge actuator 302 facilitates the rotation of the first housing portion and the second housing portion in opposite directions about the first axis. The hinge actuator 302 includes a hinge knuckle 304, a hinge shaft 306 and a hinge detent mechanism 308. The hinge knuckle 304 is coupled to the second housing portion 104 of the portable electronic device. In one embodiment, the hinge knuckle 304 may be coupled to the first housing portion of the portable electronic device. The hinge knuckle 304 is capable of rotating about the first axis and facilitates the rotation of the second housing portion with respect to the first housing portion, thereby achieving the flip-open and flip-closed positions. The hinge knuckle 304 is coupled to a first end 310 of the hinge shaft 306. The hinge shaft 306 is capable of rotating axially about the first axis 208 and couples the hinge knuckle 304 to the hinge detent mechanism 308.

The hinge detent mechanism 308 includes a hinge cam 312 and a support cam 314, which is aligned axially along the first axis on the hinge shaft 306. The hinge cam 312 essentially rotates on the support cam 314. The hinge cam 312 is capable of rotating about the first axis 208 with the rotation of the hinge shaft 306. The support cam 314 is coupled to the hinge shaft 306. The hinge cam 312 is capable of rotating on the surface of the support cam 314. The hinge detent mechanism 308 has a hinge base 316 that is placed substantially 90 degrees to the first axis. The hinge base 316 supports a spring 318. The spring 318 is placed between the support cam 314 and the hinge base 316. In one embodiment, the spring 318 may be a spring wave washer. The spring 318 supported by the hinge base 316, locks and applies tension on the support cam 314 during flip opening and flip closing of the first housing portion and the second housing portion. The spring 318 locks the support cam 314 to prevent the support cam 314 from rotating when the hinge cam 312 rotates. At the hinge base 316, a first bearing 320 is coupled to the hinge shaft 306. The first bearing 320 is placed axially along the first axis 208 and facilitates the rotation of the hinge shaft 306. When the second housing portion of the portable electronic device rotates, the hinge shaft 306 rotates with the hinge knuckle 304. The rotation of the hinge shaft 306, in turn, causes the hinge cam 312 to rotate. Due to the tension and lock applied by the spring 318 on the support cam 314, the hinge cam 312 rotates on the support cam 314 and facilitates the smooth opening and closing of the first housing portion 102 and the second housing portion.

FIG. 4 illustrates components of the second portion 206 of the hinge barrel 202. The second portion 206 includes a vibrator unit 402. The vibrator unit 402 includes an armature coil winding 404, a motor shaft 406, and an off-center mass 408. The armature coil winding 404 is placed axially along the first axis 208 between a first magnet 410 and a second magnet 412. Electric current is provided to the armature coil winding 404 from a flex 414 through electric contacts 416. The flex 414, which is placed in the hinge barrel 202, transmits electric current between the first housing portion 102 and the second housing portion 104. The electric contacts 416, in turn, transmit the electric current from the flex 414 to the armature coil winding 404. The electric current provided to the armature coil winding 404 together with the first magnet 410 and a second magnet 412 induce electromagnetic forces, that rotates the armature coil winding 404 about the first axis 208.

The armature coil winding 404 has a rotatably connected motor shaft 406 that rotates about the first axis 208. The motor shaft 406 is positioned axially along the first axis 208 and is capable of rotating with the armature coil winding 404. The rotation of the motor shaft 406 is facilitated by a bearing 418. The motor shaft 406 includes the off-center mass 408 attached to it. The off-center mass 408 is capable of rotating around the first axis 20& with the motor shaft 406. During the rotation of the armature coil winding 404, the motor shaft 406 also rotates with the off-center mass 408, thereby causing the portable electronic device to vibrate.

While the present disclosure and the best modes thereof have been described in a manner establishing possession and enabling those of ordinary skill to make and use the same, it will be understood and appreciated that there are equivalents to the exemplary embodiments disclosed herein and that modifications and variations may be made thereto without departing from the scope and spirit of the inventions, which are to be limited not by the exemplary embodiments but by the appended claims.

What is claimed is:

1. A portable electronic device having a hinge mechanism, comprising:
a hinge barrel connected to a first housing portion of the portable electronic device, the hinge barrel including a first portion and a second portion;
a hinge actuator connected to a second housing portion of the portable electronic device;
the hinge actuator enclosed in the first portion of the hinge barrel and facilitating rotation of the first housing portion and the second housing portion in opposite directions about a first axis; and
a vibrator unit enclosed in the second portion of the hinge barrel, wherein the vibrator unit is configured to vibrate the portable electronic device.

2. The device of claim 1, wherein the hinge actuator comprises:
a hinge knuckle capable of rotating about the first axis, the hinge knuckle coupled to the second housing portion; and
a hinge shaft, wherein a first end of the hinge shaft is coupled at the hinge knuckle.

3. The device of claim 2, wherein the hinge actuator further comprises a hinge detent mechanism, the hinge detent mechanism coupled to the hinge knuckle by the hinge shaft.

4. The device of claim 3, wherein the hinge detent mechanism comprises a hinge cam axially aligned along the first axis to the hinge shaft, and a spring placed between the hinge cam and the hinge base.

5. The device of claim 4, wherein the spring is a spring wave washer.

6. The device of claim 4, further comprising a first bearing placed axially along the first axis at a hinge base, the first bearing coupled to the hinge shaft facilitating the hinge shaft to rotate.

7. The device of claim 1, wherein the vibrator unit comprises:
a first magnet;
a second magnet; and
an armature coil winding, the armature coil winding located axially along the first axis between the first magnet and the second magnet.

8. The device of claim 7, wherein the vibrator unit further comprises:
a motor shaft rotatably connected to the armature coil winding along the first axis; and
an off-center mass attached to the motor shaft, the off-center mass being capable of rotating around the first axis thereby facilitating vibration.

9. The device of claim 8, wherein the armature coil winding is connected to a flex through electric contacts, the flex providing electric connections to the armature coil winding.

10. An electronic device comprising:
a first housing portion;
a second housing portion; and
a hinge barrel coupled to the first housing portion, the hinge barrel including a first portion comprising:
a hinge knuckle rotatable about a first axis, wherein the hinge knuckle is connected to the second housing portion;
a hinge shaft coupled to the hinge knuckle; and
a hinge detent mechanism coupled to the hinge knuckle by the hinge shaft, the hinge detent mechanism facilitating the first housing portion and the second housing portion to rotate in opposite directions;
the hinge barrel including a second portion comprising a vibrator unit.

11. The device of claim 10, wherein the hinge detent mechanism comprises:
a hinge base substantially 90 degrees to the first axis;
a hinge cam axially aligned along the first axis to the hinge shaft; and
a spring placed between the hinge base and the hinge cam.

12. The device of claim 11, wherein the spring is a spring wave washer.

13. The device of claim 11 further comprising a first bearing placed axially along the first axis at the hinge base, the first bearing coupled to the hinge shaft facilitating the hinge shaft to rotate.

14. The device of claim 10, wherein the vibrator unit comprises:
a motor shaft rotatably connected to an armature coil winding along the first axis; and
an off-center mass attached to the motor shaft, the off-center mass being capable of rotating around the first axis thereby facilitating vibration.

15. The device of claim 14, the armature coil winding coupled to a flex through electric contacts, the flex providing electric connections to the armature coil winding.
